(19) United States
(12) Patent Application Publication
(10) Pub. No.: US 2018/0311695 A1
(43) Pub. Date: Nov. 1, 2018

(54) COATING BOOTH

(71) Applicant: TRINITY INDUSTRIAL CORPORATION, Toyota-shi (JP)

(72) Inventors: Ryota SAITO, Toyota-shi (JP); Hideaki HARA, Obu-shi (JP)

(73) Assignee: TRINITY INDUSTRIAL CORPORATION, Toyota-shi (JP)

(21) Appl. No.: 16/026,925

(22) Filed: Jul. 3, 2018

Related U.S. Application Data
(63) Continuation of application No. PCT/JP2016/073988, filed on Aug. 17, 2016.

(30) Foreign Application Priority Data
Jan. 13, 2016 (JP) 2016-004047

(51) Int. Cl. B05B 14/43

(52) U.S. Cl. CPC B05B 14/43

(57) ABSTRACT

A coating booth includes a coating processing area that is provided in the coating booth and in which a workpiece is to be coated with atomized paint and a ceiling part from which air flows downward to remove atomized paint not adhered to the workpiece The ceiling part has an approximately quadrangular planar shape and includes a pair of air delivery units that have band-shaped areas extending along a pair of outer edge parts opposed to each other in the ceiling part, and are configured to deliver air downward, and a normal ceiling part that is provided between the pair of band-shaped areas and is configured not to deliver air. The coating processing area is entirely included in an area vertically below the normal ceiling part. The air delivered from the air delivery units has an air speed of from 0.05 m/s to 0.20 m/s.

### TECHNICAL FIELD

The present invention relates to a coating booth that has therein a coating processing area in which a workpiece is to be coated with atomized paint, and air flows downward from a ceiling part to remove atomized paint not adhered to the workpiece.

### BACKGROUND ART

As a coating booth of this type, a coating booth is conventionally known, in which an entire ceiling is configured with a mesh and a filter mat stacked on the mesh, and air flows downward in the vertically downward direction from the entire ceiling while the ceiling space is being pressurized (for example, see Patent Literature 1).

### CITATIONS LIST

Patent Literature 1: Japanese Patent Application Laid-Open No. H08-266988 (FIGS. 1 to 3)

### SUMMARY OF INVENTION

### Technical Problems

By the way, the coating gun to be used in a coating booth has a structure in which air called “a shaping air” is blown out to atomize paint, and in recent years, electrostatic coating guns have been improved such that a blowing pressure of the shaping air is reduced. In this situation, when a flow speed of the air flowing downward in the coating booth is the same as before, the atomized paint sprayed from the coating gun is blown away downward before adhering to the workpiece. To address this issue, the flow rate of the air flowing downward in the coating booth is also reduced in order to reduce the flow speed of the air. However, in the above conventional coating booth, it is difficult to sufficiently reduce the flow rate of the air in the coating processing area, and improvement has been required.

The present invention has been made in view of the above circumstances, and an object of the invention is to provide a coating booth in which air can be flowed. downward, at a flow rate smaller than that in the conventional, in a coating processing area in which a workpiece is to be coated.

### Solutions To Problems

A coating booth includes a coating processing area that is provided in the coating booth and in which a workpiece is to be coated with atomized paint and a ceiling part from which air flows downward to remove atomized paint not adhered to the workpiece, wherein the ceiling part has an approximately quadrangular planar shape and includes a pair of air delivery units that have band-shaped areas extending along a pair of outer edge parts opposed to each other in the ceiling part, and are configured to deliver air downward, and a normal ceiling part that is provided between the pair of band-shaped areas and is configured not to deliver air, wherein the coating processing area is entirely included in an area vertically below the normal ceiling part and the air delivered from the air delivery units has an air speed of from 0.05 m/s to 0.20 m/s.

### BRIEF DESCRIPTION OF DRAWINGS

FIG. 1 is a sectional side view of a coating booth at an intermediate position in a longitudinal direction.

FIG. 2 is a sectional side view of the coating booth at an intermediate position in a short-side direction.

FIG. 3 is a sectional side view of an air supply duet.

FIG. 4 is a simulation result at a first flow speed.

FIG. 5 is a simulation result at the first flow speed.

FIG. 6 is a simulation result at a second flow speed.

FIG. 7 is a simulation result at the second flow speed.

FIG. 8 is a simulation result at a third flow speed.

FIG. 9 is a simulation result at the third flow speed.

FIG. 10 is a simulation result at a fourth flow speed.

FIG. 11 is a simulation result at the fourth flow speed.

FIG. 12 is a simulation result at a fifth flow speed.

FIG. 13 is a simulation result at the fifth flow speed.

### DESCRIPTION OF EMBODIMENTS

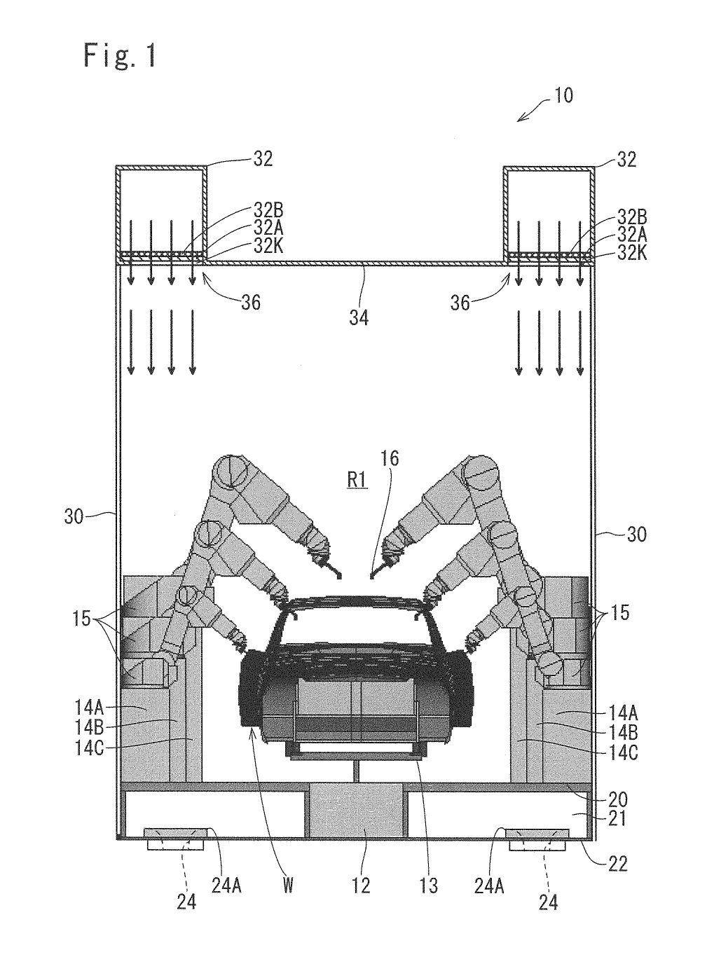

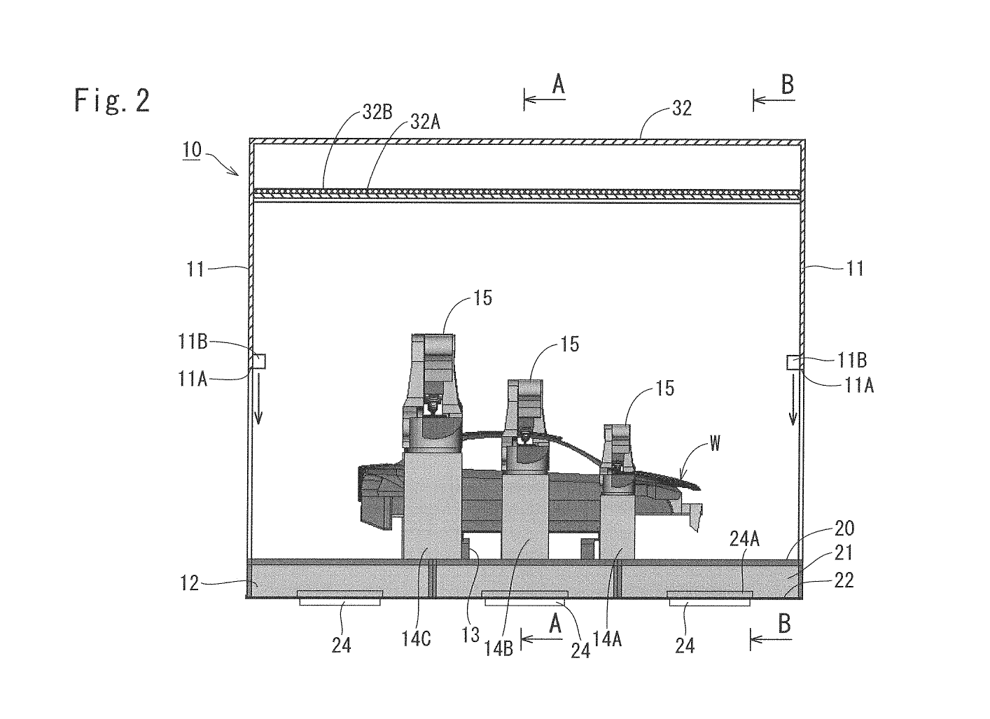

Hereinafter, an embodiment of the present invention will he described with reference to FIGS. 1 to 3. A coating booth 10 of the present embodiment shown in FIGS. 1 and 2 has a rectangular planar shape and includes carry-in/out ports 11A and 11A on a pair of shorter-side walls 11 and 11 (see FIG. 2). Further, a conveyance passage 12 shown FIG. 1 runs through both of the carry-in/out ports 11A and 11A. A conveyor carriage 13 carrying thereon a workpiece W such as a vehicle body moves in one direction on the conveyance passage 12 to pass through inside the coating booth 10.

Note that, as shown in FIG. 2, each carry-in/out port 11A is covered by an air curtain generated by an air curtain generator 11B equipped on an upper opening edge of each carry-input port 11A.

Duckboards 20 are provided on both sides of the conveyance passage 12 in the coating booth 10. Support platforms 14A, 14B, and 14C respectively having different heights (large, medium, and small) as shown in FIG. 2 are provided on the duckboards 20. Then, a coating robot 15 is mounted on each of the support platforms 14A, 14B, and 14C. A group of the coating robots 15A surrounds a coating processing area R1 in which a workpiece W is to be coated.

In detail, the support platforms 14A, 14B, and 14C have, for example, pillar shapes extending straight in a vertical direction, are arranged at intervals along the conveyance passage 12, and are adjacent to a pair of longer-side walls 30 and 30 as shown in FIG. 1. Further, each of the coating robots 15 is a so-called vertical articulated robot and is serially equipped, on a pivot base that is pivotable horizontally, with a first arm, a second arm, and a wrist. An electrostatic coating gun 16 (see FIG. 1) is mounted on a top end part of the wrist. The coating gun 16 has a structure similar to the structure disclosed in, for example, Japanese Patent Application Laid-Open No. 2013-166113, and sprays atomized paint in a charged state so that the atomized paint is adhered to the workpiece W by using attraction force of static electricity.

An underfloor room 21 is provided below the duckboards 20. A suction room (not shown) that is separated from the underfloor room 21 by an underfloor separation. plate 22 is provided further below the underfloor room 21. Further, the underfloor separation plate 22 has a plurality of air suction ports 24 formed therein on the both side parts in a short-side direction of the coating booth 10. An annular ridge 24A protrudes upward from the opening edge of each of the air suction ports 24. Then, air is sucked through an exhaust duct (not shown) connected to the suction room in a state that water is reserved on the upper surface of the underfloor separation plate 22, up to the height of the annular ridges 24A. A flow rate of the air sucked is approximately the same as the flow rate of the air blown out into the coating booth 10 from an air supply duct 32 to be described later.

As shown in FIG. 1, the ceiling part of the coating booth 10 has a pair of air delivery units 36 and 36 extending along the outer edge parts on the pair of longer sides of the ceiling part. The ceiling part includes, between the pair of air delivery units 36 and 36, a normal ceiling part 34 that does not deliver air. Further, the coating processing area R1 is entirely covered by the normal ceiling part 34 from above.

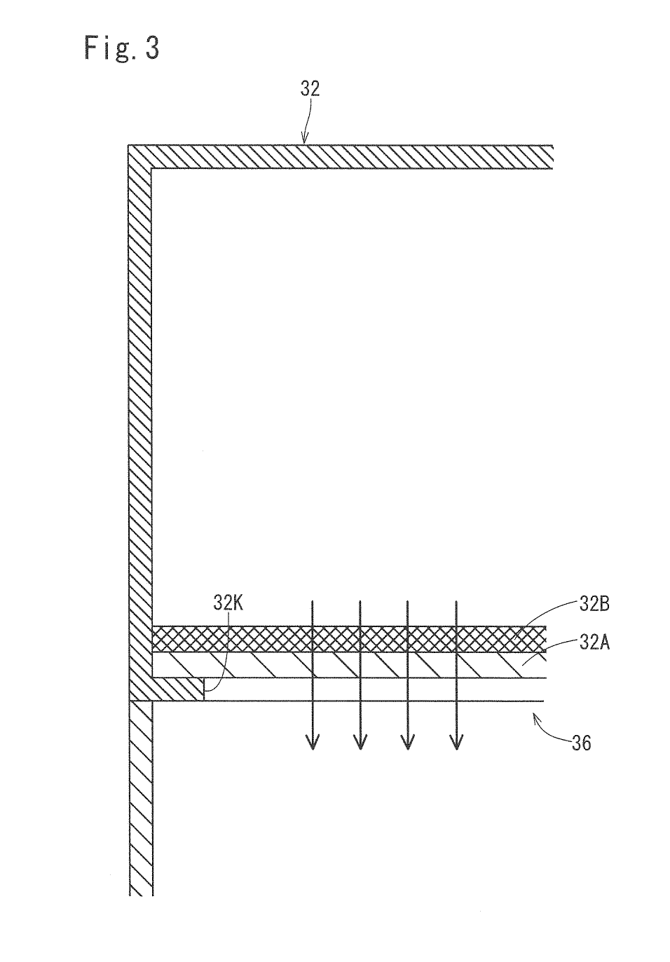

Specifically, the ceiling part of the coating booth 10 includes a pair of air supply ducts 32 and 32 extending along the outer edge parts on the pair of longer sides of the ceiling part. A flat plate member extends between the lower end parts of the surfaces opposed to each other in the pair of air supply ducts 32 and 32, and constitutes the normal ceiling part 34 described above. Further, each of the air supply duct 32 has a rectangular cross-sectional shape. The lower surface of the air supply duct 32 is cut away approximately entirely except the both side edge parts in a width direction to form a lower surface opening 32K as shown in FIG. 3. Further, a mesh 32A is laid such that the lower surface opening 32K is closed from inside of the air supply duct 32, and a filter mat 32B is laid on the mesh 32A. Thus, the entire part of the lower surface of the air supply duct 32 except its both side edge parts constitutes the air delivery unit 36. With this arrangement, band-shaped areas that extend along a pair of outer edge parts of the ceiling part of the coating booth 10 constitute the pair of air delivery units 36 and 36. Note that in the present embodiment, “an air-permeable pressure reduction member” of the present invention includes a mesh 32A and a filter mat 32B.

Although not shown in the drawings, an air conditioner (not shown) is connected to the approximately central part, in the longitudinal direction, on one side surface of each of the air supply duct 32. The air conditioner conditions mixed air that is mixture of external air and air sucked through the air suction ports 24 described above, to a predetermined humidity and temperature by heating, cooling, humidifying, and other treatments. The air conditioner then feeds the conditioned mixed air to the air supply duct 32. With this arrangement, air is delivered vertically downward from the pair of air delivery units 36 and 36.

The above is a description of the structure of the coating booth 10 of the present embodiment. Next, an operation and effect of the coating booth 10 will be described. When the coating booth 10 is operated, compressed air is fed from the air conditioner, and an internal pressure of each of the air supply duct 32 is thus raised. Accordingly, the air is delivered vertically downward from the entire air delivery unit 36 at a flow rate in accordance with the internal pressure. Then, the air passes through around the coating robots 15 and the support platforms 14A, 14B, and 14C, and is then sucked downward below the duckboards 20. At that time, the atomized paint around the coating robots 15 and the support platforms 14A, 14B, and 14C is also sucked downward below the duckboards 20. Further, the air flows downward around the coating processing area R1 surrounded by the group of coating robots 15 as described above. Accordingly, the air slowly flows downward in accordance with the air flowing down around the coating processing area R1. By this airflow, the atomized paint that is not adhered to the workpiece W in the coating processing area R1 is also discharged downward below the Buckboards 20.

As described above, in the coating booth 10 of the present embodiment, when air is delivered downward from the pair of air delivery units 36 and 36 provided on the pair of outer edge parts of the ceiling part, the air vertically below the normal ceiling part 34 between the pair of air delivery units 36 and 36 is affected by the air delivered from the air delivery units 36 and 36, and thus flows downward extremely slowly. Further, since the coating processing area R1 in which the workpiece W is to be coated is disposed vertically below the normal ceiling part 34, the flow rate of the air flowing downward in the coating processing area R1 can be smaller than that in the conventional. With this arrangement, even though the coating robot 15 includes the coating gun 16 having a relatively low blowing pressure of the shaping air, the coating robot 15 can perform high quality coating.

Further, in the present embodiment, the conveyance passage 12 for carrying a vehicle body as the workpiece W is provided on a floor surface. The support platforms 14A, 14B, and 14C are provided on the both sides across the conveyance passage 12. The coating robots 15 are disposed on the support platforms 14A, 14B, and 14C. The band-shaped areas of the ceiling part constituting the air delivery units 36 are so wide as to entirely cover the support platforms 14A, 14B, and 14C. Accordingly, the paint is more effectively prevented from being adhered to the coating robots 15 and the support platforms 14A, 14B, and 14C.

Further, in the present embodiment, the Buckboards 20 are provided on the both sides of the conveyance passage 12 in the coating booth 10. The air suction ports 24 are disposed on the both side parts, below the duckboard 20, corresponding to the pair of air delivery units 36 and 36. Accordingly, the air delivered from the pair of air delivery units 36 and 36 is mainly sucked through the air suction ports 24, and the air in the coating processing area can be prevented from being affected by the air suction ports.

### EXAMPLES

A fluid analysis simulator was used to study the airflow on the A-A cross-section and the B-B cross section in FIG. 2 when air was delivered from the pair of air delivery units 36 and 36 of the coating booth 10 described in the above embodiment, under the following experimental conditions.

### A. Experimental Conditions

### (1) Fixed Conditions

Height from the duckboard 20 to the normal ceiling part 34: 4,300 mm

Interval between the longer-side walls 30 and 30: 4,000 mm

Air temperature: 20° C.

### (2) Varied Conditions

Flow speed of the air delivered from the air delivery units 36:
First flow speed: 0.10 m/s
Second flow speed: 0.15 m/s
Third flow speed: 0.20 m/s
Fourth flow speed: 0.25 m/s
Fifth flow speed: 0.30 m/s

### B. Experimental Results

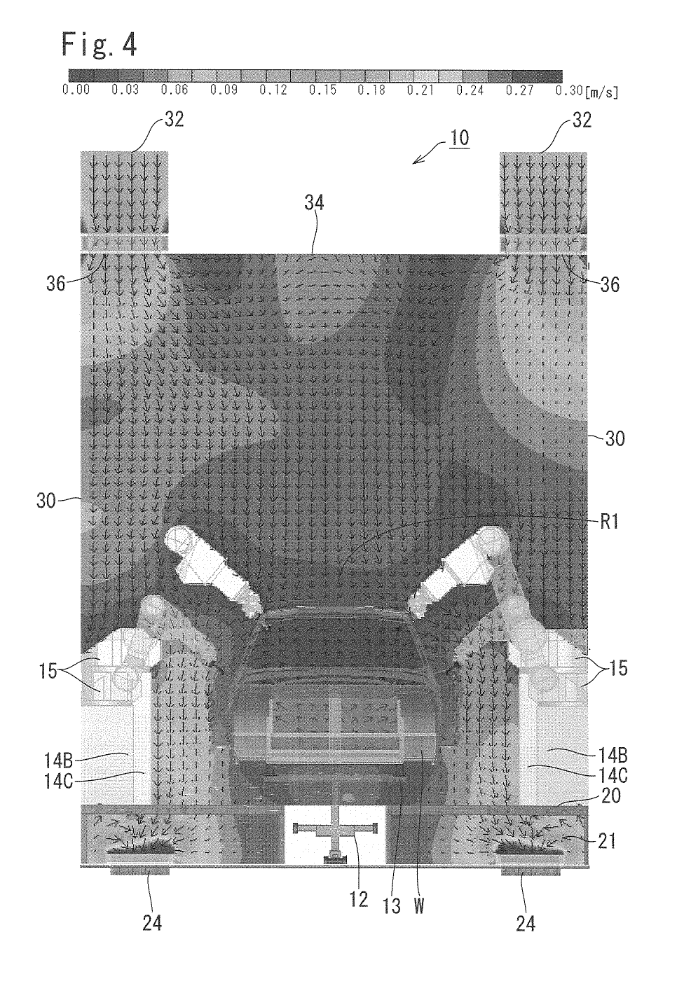

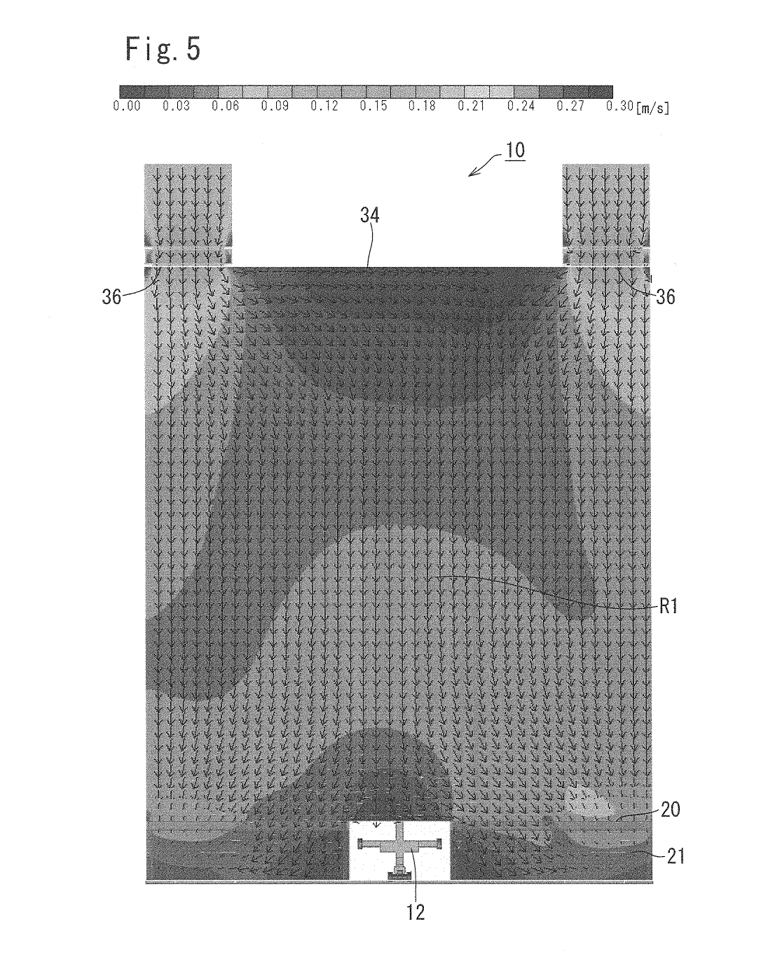

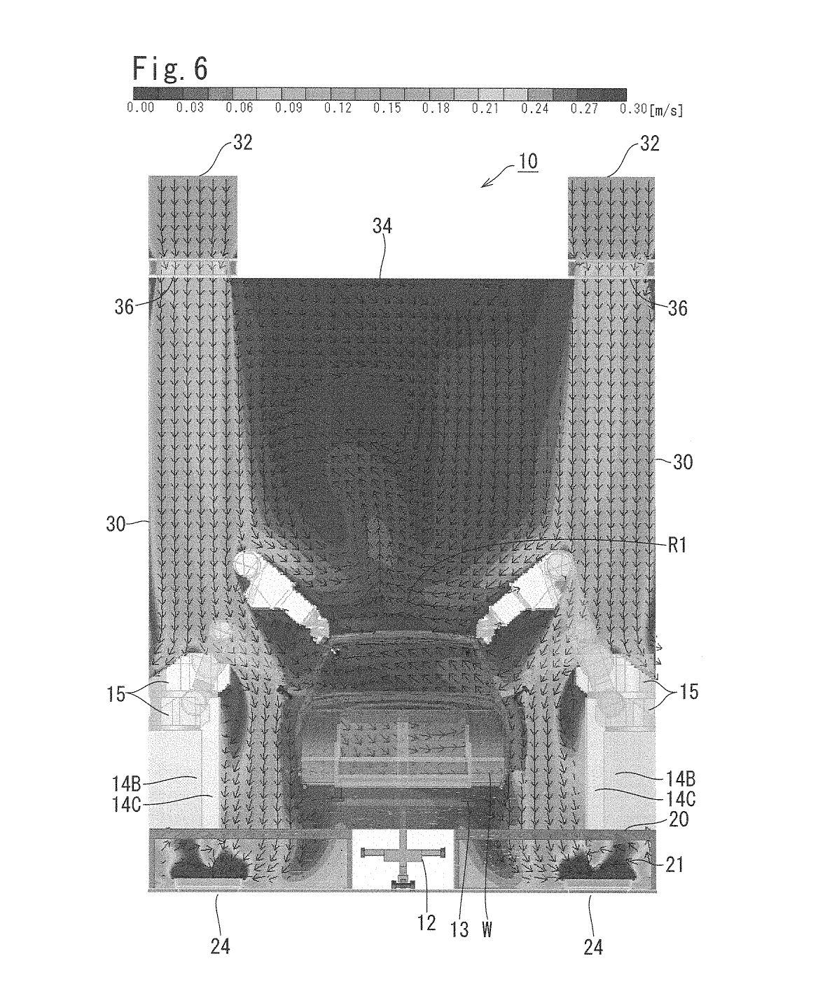

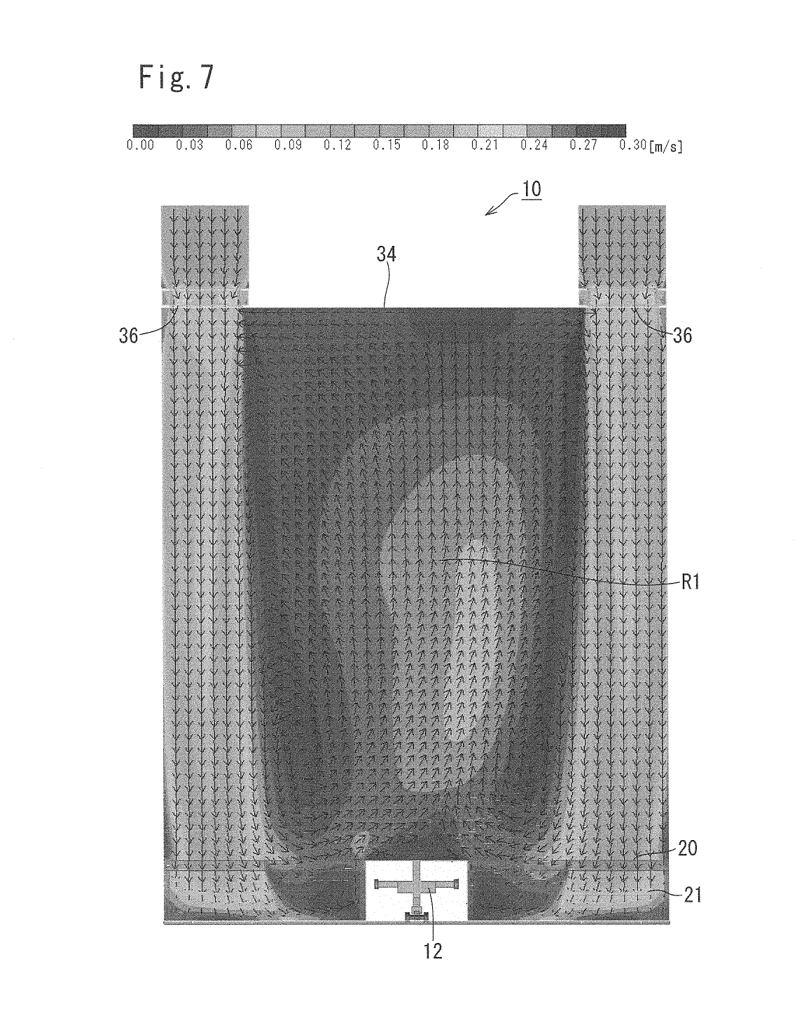

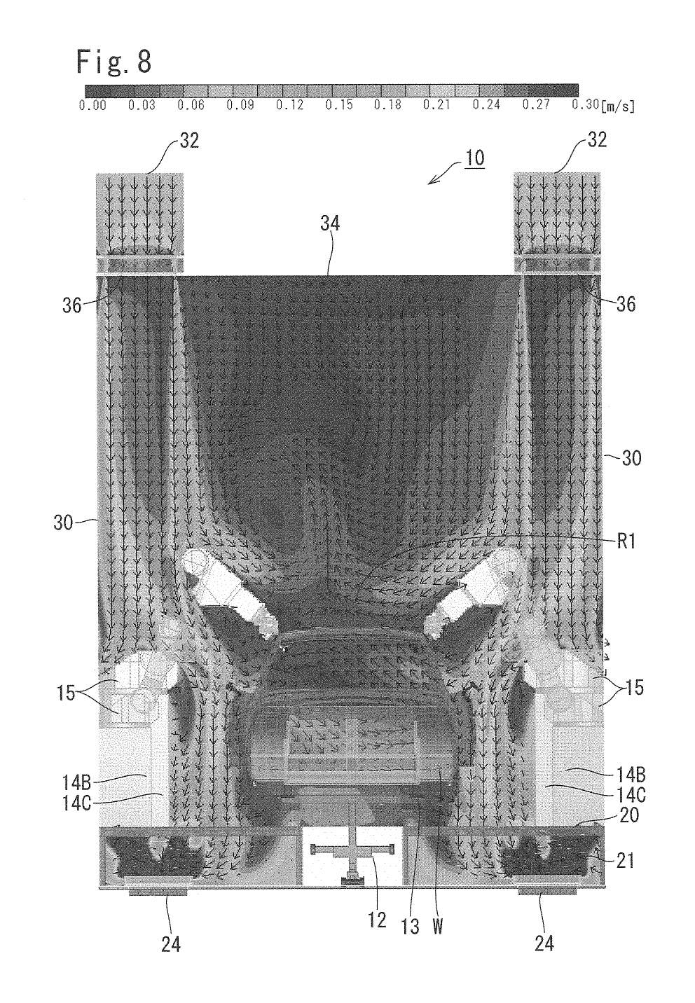

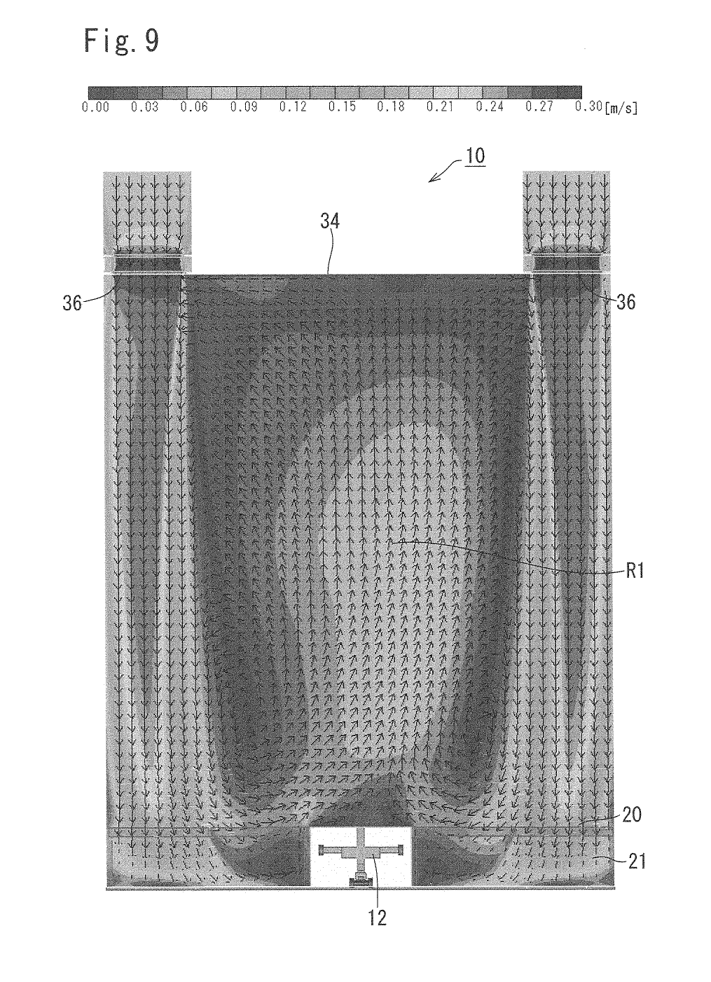

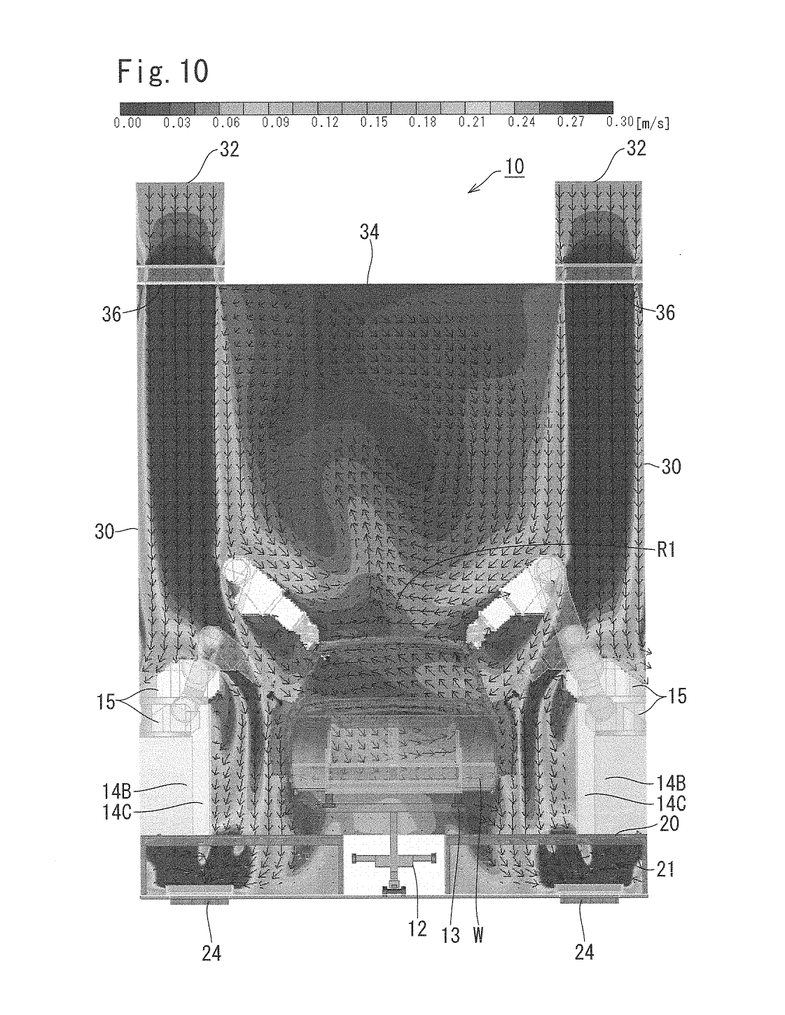

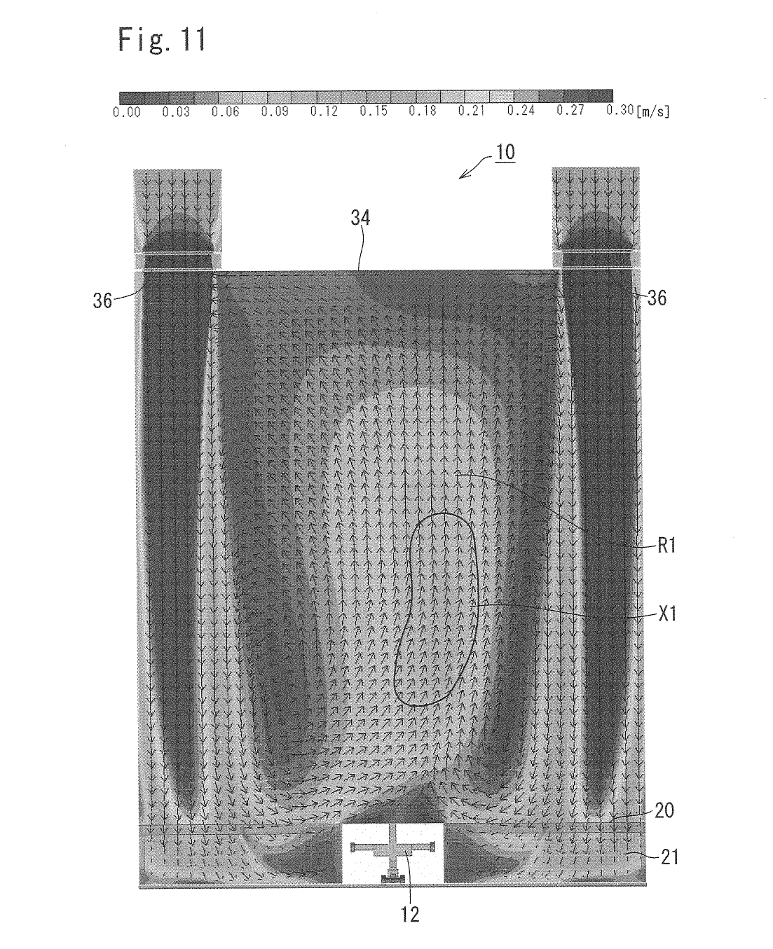

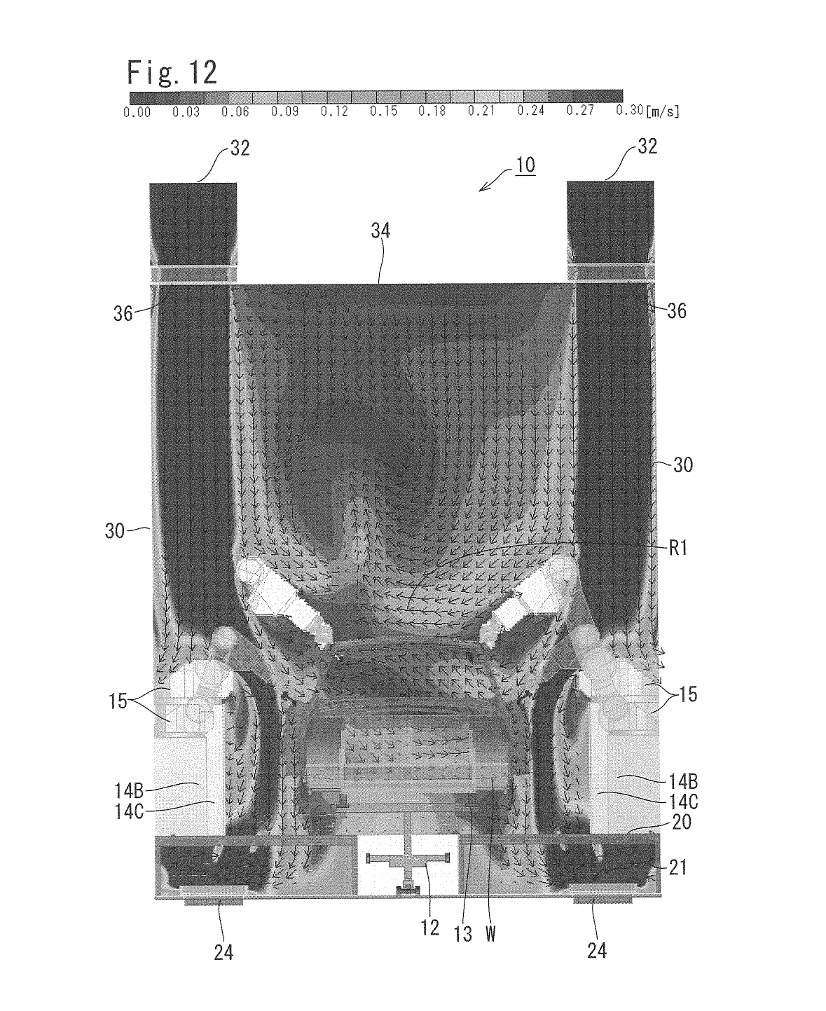

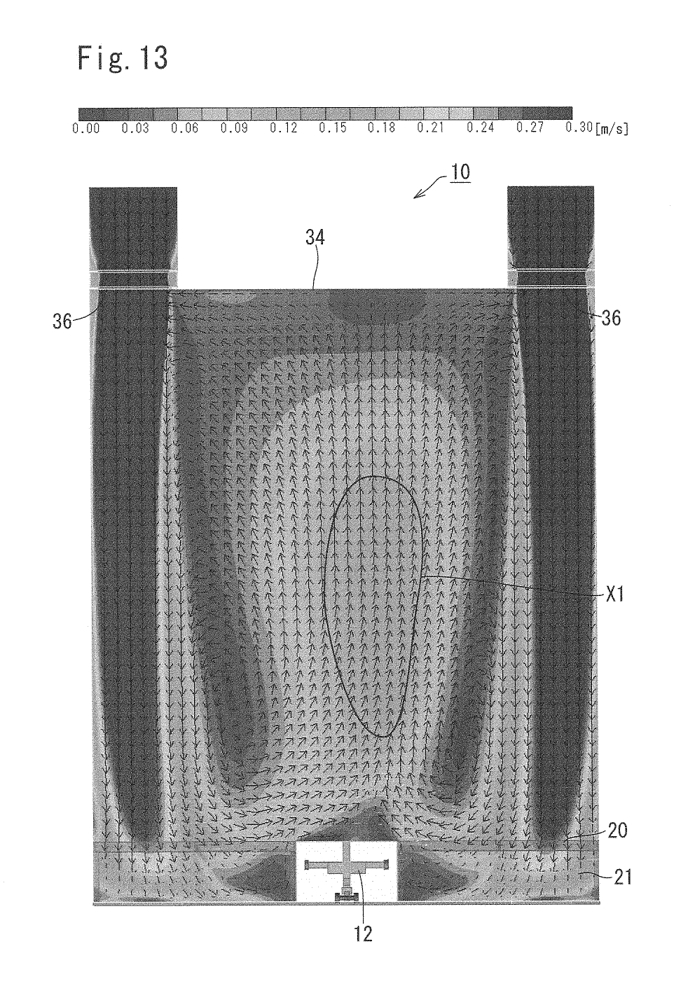

Simulation results for the first flow speed: FIGS. 4 and 5
Simulation results for the second flow speed: FIGS. 6 and 7
Simulation results for the third flow speed: FIGS. 8 and 9
Simulation results for the fourth flow speed: FIGS. 10 and 11
Simulation results for the fifth flow speed: FIGS. 12 and 13

Note that the simulation results are actually displayed in colors.

When the flow speed (hereinafter referred to as the “blowing speed”) of the air delivered from the air delivery units 36 was set to 0.10 m/s, there occurred no blowing up of air (ascending air) in the coating booth 10, at the position where the workpiece W existed (see FIG. 4) or the position where the workpiece W did not exist (see FIG. 5). When the blowing speed was set to 0.15 m/s or more, there occurred blowing up of air both at the position Where the workpiece W existed (see FIG. 6) and the position where the workpiece W did not exist (see FIG. 7). However, when the blowing speed was 0.15 m/s, the flow speed of the blowing-up air was 0.05 m/s or less, which was not high enough to greatly affect coating quality or contamination of the coating robots 15. Further, the blowing speed was set to 0.20 m/s, the flow speed of the blowing-up air was 0.07 m/s or less, which was also not high enough to greatly affect coating quality or contamination of the coating robots 15, In contrast, when the blowing speed was set to 0.25 m/s or more, the flow speed of the blowing-up air was 0.1 m/s or more (see X1 in FIGS. 11 and 13) in an area at the position where the workpiece W did not exist (see FIGS. 11 and 13), which can affect coating quality and contamination of the coating robots 15. Note that it is known by experience that when the blowing speed is set to less than 0.05 m/s, it is extremely difficult to keep the blowing speed, which cannot be confirmed by the simulation.

From the above results, it is understood that the blowing speed is preferably no greater than a value ranging from 0.05 m/s to 0.20 m/s, and is more preferably no greater than a value ranging from 0.05 m/s to 0.15 m/s.

### OTHER EMBODIMENTS

The present invention is not limited to the above embodiment, and, for example, the embodiments described below are also included in the technical scope of the present invention. In addition, other than the following embodiments, the present invention can be variously modified and practiced without departing from the spirit of the invention.

(1) In the coating booth 10 of the above embodiment, only the pair of outer edge parts of the ceiling part is in a duct structure. Alternatively, the entire ceiling part may be made in a duct structure, and air may be delivered from only the pair of outer edge parts of the ceiling part.

(2) In the coating booth 10 of the above embodiment, the air suction ports 24 are disposed on the both side parts of the underfloor separation plate 22. Alternatively, an air suction port may be disposed on a central part or near the central part.

(4) In the above embodiment, each of the air delivery units 36 includes a mesh and a filter mat. Alternatively, only a mesh or a filter mat may he used, or any member other than a mesh and a filter mat through which air can pass with a pressure loss may also be used.

### REFERENCE SIGNS LIST

10: Coating booth.
20: Duckboard
24: Air suction port
32: Air supply duct
34: Normal ceiling part
36: Air delivery unit
R1: Coating processing area
W: Workpiece

1. A coating booth comprising:
a coating processing area that is provided in the coating booth and in which a workpiece is to be coated with atomized paint; and
a ceiling part from which air flows downward to remove atomized paint not adhered to the workpiece,
wherein the ceiling part has an approximately quadrangular planar shape and includes:
a pair of air delivery units that have band-shaped areas extending along a pair of outer edge parts opposed to each other in the ceiling part, and are configured to deliver air downward; and
a normal ceiling part that is provided between the pair of band-shaped areas and is configured not to deliver air,
wherein the coating processing area is entirely included in an area vertically below the normal ceiling part; and
wherein the air delivered from the air delivery units has an air speed of from 0.05 m/s to 0.20 m/s.

2. The coating booth. according to claim 1, wherein the air delivered from the air delivery units has an air speed of 0.15 m/s or less.

3. The coating booth according to claim 1, further comprising:
a pair of ducts that extend along the pair of outer edge parts of the ceiling part,
wherein an approximately entire lower surface of each of the pair of ducts includes a filter, a mesh, or an air-permeable pressure reduction member through which air passes with a pressure loss and constitutes the air delivery unit, and
wherein the normal ceiling part includes a flat plate arranged between lower end parts of surfaces opposed to each other in the pair of ducts.

4. The coating booth according to claim 1, further comprising:
a conveyance passage that is provided on a floor surface in the coating booth to carry a vehicle body as the workpiece;
support platforms that are provided on both sides of the conveyance passage, sandwiching the conveyance passage therebetween; and
coating robots that have an electrostatic coating gun and are arranged on the support platforms,
wherein each of the band-shaped areas is so wide as to entirely cover the support platforms from above.

5. The coating booth according to claim 1, further comprising:
a floor panel that has a duckboard structure; and
air suction ports that are provided in both side parts below the floor panel, the both side parts being corresponding to the pair of air delivery units.

6. A method for coating a workpiece in a coating booth according to claim 1.

7. The method for coating the workpiece in the coating booth according to claim 2.

8. The method for coating the workpiece in the coating booth according to claim 3.

9. The method for coating the workpiece in the coating booth according to claim 4.

10. The method for coating the workpiece in the coating booth according to claim 5.
